(19) United States
(12) Patent Application Publication
(10) Pub. No.: US 2008/0127636 A1
(43) Pub. Date: Jun. 5, 2008

(54) Integrated diesel particulate trap pressure sensor

(76) Inventor: Daniel R. Dahlgren, Cicero, IN (US)

Correspondence Address: DELPHI TECHNOLOGIES, INC., M/C 480-410-202, PO BOX 5052, TROY, MI, 48007, US

(21) Appl. No.: 11/606,439

(22) Filed: Nov. 30, 2006

(51) Int. Cl. F01N 3/023; G01M 15/04; F02D 41/00; F02M 25/07

(52) U.S. Cl. 60/295; 123/676; 123/568.11

(57) ABSTRACT

An apparatus for monitoring the condition of a particulate filter situated within the exhaust flow path of a combustion engine, the apparatus comprising: means defining an exhaust gas recirculation (EGR) passage; means located within said exhaust gas recirculation (EGR) passage for sensing pressure and generating a signal indicative thereof; and computing means arranged to derive a pressure reduction value corresponding to the signal generated by said pressure-sensing means. The computing means will then determine whether said pressure reduction value exceeds a predetermined value and provide an indication of an unacceptable condition of the particulate filter.

### FIELD OF THE INVENTION

The present invention relates to an apparatus and a method for monitoring the condition of a particulate filter situated within an exhaust gas flow path of an internal combustion engine, such as, a diesel exhaust system in a motor vehicle. The present invention further relates to an apparatus and a method for optimising a regeneration cycle of such a particulate filter.

### BACKGROUND

There are a growing number of environmental concerns associated with the particulates that are emitted from motor vehicles. In particular, motor vehicles, especially those powered by diesel fuel, emit particulate matter in the form of dust and soot. Such emissions contribute significantly to global pollution.

A number of public health problems related to respiration have resulted from a greater than acceptable quantity of particulates in the air, especially in urban areas. Such problems commonly take the form of aggravated asthma and lung damage, largely due to the ability of the small-sized particles to penetrate deep into human and animal lung cavities. There is also strong evidence to suggest that particulates of this nature are carcinogenic to humans, particularly children.

It is apparent that aspects of the environment have also undergone detrimental effects as a result of pollution resulting from particulates in exhaust gases, such as increased haze and a general reduction in visibility.

In response to the health and environmental concerns countries have passed regulatory provisions which require particulate emissions from exhausts, e.g. that of motor vehicles, to below an acceptable limit. This limit varies dependent on vehicle type and fuel type.

An exhaust system, for example in a motor vehicle, comprises at least three main structural parts: an exhaust manifold; an exhaust pipe; and a silencer. The exhaust manifold collects the exhaust gas from each engine cylinder and feeds the gas into a single exhaust pipe so that it may be expelled from the vehicle. It is known to include a particulate trap in the exhaust pipe of the exhaust system. The exhaust gas containing the particulates is filtered as it passes through the particulate trap, and a proportion of the particulates are removed from the stream of the exhaust gases, thus reducing the quantity of particulates released into the environment.

Typically a particulate trap will operate such that there will be a first period in which the particulate matter is collected within the filter, followed by a second, shorter, period during which the filter is regenerated by heating so as to cause the trapped particulates to burn off and thereby expelled from the filter as gases. These two periods alternate so that the trap continues to work efficiently and does not impair the working of the engine.

It is imperative that the trap prevents the particulate output from increasing to a level which would exceed the acceptable emission limit, for example, following a period of incomplete combustion.

In addition, the trap itself must not give rise to a significant back-pressure within the exhaust flow path, since this could have adverse effects on the engine, such as increased fuel consumption and increased pollutant emissions.

There are many other criteria, e.g. trap size, weight, thermal inertia, muffling, surface temperature, each of which may effect the operation of the trap.

Accordingly, it is desirable to monitor the performance of the trap i.e. the build-up of particle matter in the particulate trap, so that it can be ascertained whether or not the trap is operating satisfactorily. Further, should the operation of the trap need to be altered, this information could be used to better determine the frequency at which the filter is regenerated.

By measuring the pressure of the exhaust gas, both at a position upstream of the particulate trap and at a position downstream thereof, the efficiency of the trap can be monitored.

It is known to use pressure sensors in order to monitor the working of the trap. Specifically, it is known to provide two or more pressure sensors in the exhaust pipe, at least one upstream of the trap and at least one other downstream of the trap. Each sensor periodically measures the pressure, and the difference between the readings is determined to provide a value for the reduction in pressure across the particulate trap. This value is compared with standard values for the particular trap in order to determine when the trap becomes clogged with particulates.

The above method has a number of disadvantages. For example, the sensors must be able to operate at the high temperatures encountered in the region of the particulate trap, which can reach up to 800 degrees Celsius during regeneration cycles. As a result these sensors must be manufactured from materials which can withstand such high temperatures, which increases the cost of such sensors.

An alternative possibility is to install special ducts that feed a portion of the exhaust gas from the inlet and outlet of the trap to a single differential pressure sensor. However, additional costs are incurred for the vehicle-specific plumbing that is required, e.g. supplying and positioning of the extra piping, ducts and fittings.

It is also known to use a single calibrated pressure sensor on the inlet passage to the particulate trap, and this can reduce cost. In order to calibrate the sensor, pressure readings will have been periodically collected from the upstream and downstream sensors described previously. The pressure drop across the particulate trap is determined by measuring the difference between the two pressure values. This data forms the basis of a reference table enabling the value of the pressure drop to be determined from a single reading at the inlet pressure sensor at a later time.

Whilst this is an improvement over the previous art, it nevertheless requires at least one heat-resistant sensor.

In order to obviate the need for at least one heat-resistant sensor, a more moderately heat-resistant sensor could be positioned at a greater distance from the particulate trap, e.g. further upstream from the particulate trap and in close proximity to the location where exhaust pipe and the exhaust manifold join. However, this would require redesign and repositioning of the components that are associated with the sensor's operation, e.g. wiring that is connected to the wire loom and means for attaching the sensor in the correct position in the exhaust pipe.

A fundamental drawback of all the above-described art is that each requires electrical wires to be routed into under-protected body areas of the vehicle, e.g. those exposed to debris or splash. As a result, such sensor systems require additional design to reduce the risks of short circuits and other electrical hazards.

Each of the above-described sensing systems requires the provision of components additional to those which inherently exist in the exhaust system, thereby increasing the complexity, weight and cost.

It is apparent that there is a need for a simple and cost-effective method and apparatus for measuring the pressure reduction across a particulate trap so as to optimise the time of commencement of the regeneration cycle.

### SUMMARY OF THE INVENTION

This invention seeks to overcome or alleviate the aforementioned problems in the prior art.

According to a first aspect of the present invention there is provided an apparatus for monitoring the condition of a particulate filter situated within the exhaust flow path of a combustion engine, which combustion engine comprises a plurality of combustion cylinders and is provided with means defining a feedback path for causing a portion of the exhaust gas from the cylinders to flow back to an inlet of the cylinders, there being provided within the feedback path a pressure sensor for measuring the pressure of the gas within the feedback path and for generating an output signal in response thereto, the apparatus comprising:

means for evaluating the output signal to determine whether the pressure within the feedback path has exceeded a predetermined value; and

means responsive to a positive determination of the evaluating means for providing an indication of an unacceptable condition of the particulate filter.

In preferred embodiment the feedback path is provided with a valve for selectively causing an open and a closed condition of the feedback path, the apparatus further comprising means for sensing a closed condition of the valve and for enabling the receiving means only when the valve is sensed by the sensing means as being in a closed condition.

In a further aspect the invention resides in an apparatus for monitoring the condition of a particulate filter situated within the exhaust flow path of a combustion engine, the apparatus comprising:

means defining an exhaust gas recirculation (EGR) passage;

means located within said exhaust gas recirculation (EGR) passage for sensing pressure and generating a signal indicative thereof; and

computing means arranged to derive a pressure reduction value corresponding to the signal generated by said pressure-sensing means and to determine whether said pressure reduction value exceeds a predetermined value, thereby to provide an indication of an unacceptable condition of the particulate filter.

A typical exhaust gas re-circulation (EGR) system comprises a duct or passage which enables a portion of the exhaust gas to flow from an exhaust manifold back into the cylinders' intake stream (the remainder of which flows into the exhaust pipe). The exhaust gas serves to reduce the concentration of oxygen in the air stream that is supplied to the cylinders. As a result, the combustion temperature is lowered by several hundred degrees and this reduces the level of NOx gases formed during operation of the engine. The EGR passage includes a valve, operable to open or close the passage, either wholly or partly, to control the flow of exhaust gas into the cylinders' intake stream.

Importantly, when the EGR valve is closed, the pressure of the gas at the position immediately upstream of the valve is substantially the same as the pressure of the gas immediately upstream of the particulate trap in the exhaust pipe.

Therefore, in one embodiment, the EGR passage is provided with means, such as a valve, arranged to open or close the EGR passage, thereby to control the flow of exhaust gas through the EGR passage, the apparatus further comprising means for sensing a closed condition of the valve and for enabling the generation of the signal only when the valve is sensed by the sensing means as being in a closed condition.

When the valve is closed it is desirable that the pressure sensing means is arranged to measure the pressure of the gas flowing within the inlet i.e. upstream side of the EGR passage, or feedback path, immediately upstream of the valve. It is preferable that the pressure-sensing means or the pressure sensor is located on an inlet side of the valve in the EGR passage, or in the feedback path to ensure the pressure is recorded accurately.

If the exhaust system of interest is located in a motor vehicle for example, the computing means may be an Engine Control Module ‘ECM’, arranged to derive pressure reduction information from pressure information provided by the pressure sensing means.

In particular, the apparatus may comprise at least one look-up table arranged to enable said computing means or ECM to derive a pressure reduction value corresponding to the signal generated by said pressure-sensing means.

The look-up table is provided for mapping a plurality of possible values of the output of the signal with corresponding values for the pressure differences across the particulate filter which have been obtained empirically, thereby to determine an evaluation of whether of the pressure in the EGR passage, or feedback path, exceeds the value of the maximum acceptable pressure difference across the particulate filter.

The above-described aspects of the invention further relate to initiating the regeneration of a particulate filter. In particular the apparatus further preferably comprises a filter regenerating means, wherein the computing means or receiving means according to the above-described aspects of the invention are arranged to cause initiation of filter regenerating means when said pressure reduction value exceeds said predetermined value.

In a third aspect the invention resides in a method of monitoring the condition of a particulate filter situated within the exhaust flow path of a combustion engine, which combustion engine comprises a plurality of combustion cylinders and is provided with means defining a feedback path for causing a portion of the exhaust gas from the cylinders to flow back to an inlet of the cylinders, there being provided within the feedback path a pressure sensor for measuring the pressure of the gas within the feedback path and for generating an output signal in response thereto, the method comprising:

evaluating the output signal to determine whether the pressure within the feedback path has exceeded a predetermined value; and

responding to a positive determination that the predetermined value has been exceeded, thereby to provide an indication of an unacceptable condition of the particulate filter.

Preferably, the feedback path is provided with a valve for selectively causing an open and a closed condition of the feedback path, the method further comprising sensing a closed condition of the valve and enabling the receiving means only when the valve is sensed by the sensing means as being in a closed condition.

In a fourth aspect there is provided a method for monitoring the condition of a particulate filter situated in an exhaust of a combustion engine, comprising the steps of:

sensing pressure of exhaust gas within a means defining an exhaust gas recirculation (EGR) passage using a pressure sensor;

generating a signal indicative of said pressure to a computing means;

deriving a pressure reduction value indicative of said pressure value; and

determining whether said pressure reduction value exceeds a predetermined value, thereby to provide an indication of an unacceptable condition of the particulate filter.

The method may further comprise mapping via a look-up table, a plurality of possible values of the output of the signal with corresponding values for the pressure differences across the particulate filter which have been obtained empirically, thereby to determine an evaluation of whether of the pressure in the EGR passage, or feedback path, exceeds the value of the maximum acceptable pressure difference across the particulate filter.

The method further preferably comprises initiating filter regeneration, when said pressure reduction value exceeds said predetermined value.

It is desirable that, following regeneration of the particulate filter, the gas pressure value is immediately re-measured to ascertain the extent of pressure reduction has in fact occurred.

Thus, the method of monitoring the particulate filter may further comprise re-measuring the pressure reduction value of the exhaust gas within the EGR means at such time as said filtration means has completed a cycle.

The look-up table values, utilised to identify the pressure reduction value, and the predetermined pressure value, used as a comparison with the pressure reduction value to determine the condition of the particulate filter will become increasingly inaccurate over time. There is only nominal back pressure experienced when the exhaust system is new, however, it is subject to gradual change in back pressure as the engine gets older largely due to degradation of the exhaust system. For example, due to the formation of small holes in the pipe work or to the constriction of pipe work as soot builds on the interior surface. It is desirable to modify the look-up table and predetermined value to account for these changes.

Therefore it is advantageous to accurately monitor a particulate system situated within
the exhaust flow path of a combustion engine by accounting for the gradual change in back-pressure experienced in the exhaust over time.

Thus, the method may further comprise:

utilising an algorithm arranged to modify the look-up table and to modify the predetermined pressure value,

such that the said look-up table and predetermined pressure value remain accurate over the working life time of the internal combustion engine.

Any aspect of the present invention can be applied to an engine, such as a diesel engine of a motor vehicle.

### DRAWINGS

The invention will now be described, by way of example only, with reference to the accompanying drawings in which:

FIG. 1 is a representation of the apparatus according to a preferred embodiment of the present invention; and

FIG. 2 is a representation of a learning process algorithm for use with the present invention.

### DETAILED DESCRIPTION

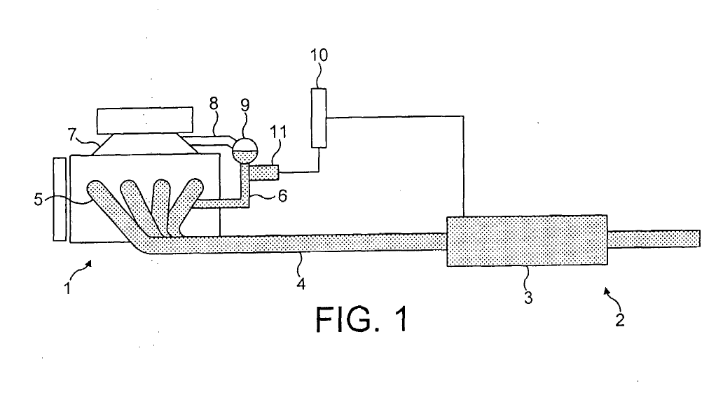

Referring now to FIG. 1, there is provided an apparatus for monitoring the condition of a particulate filter.

An internal combustion engine 1 is provided with an exhaust system 2. Within the exhaust system 2 there is a particulate filter 3, located in an exhaust pipe 4 and arranged to filter the exhaust gases flowing from the engine 1, thereby to reduce the quantity of particulate matter in the exhaust gas that is expelled into the atmosphere.

As the exhaust gas flows from the engine's multiple cylinders 7 (within the engine) it enters the exhaust manifold 5, which serves to collect the exhaust gas from each cylinder and recombine it into a single flow path, and later exits the manifold 5 and flows into the exhaust pipe 4.

The exhaust manifold 5 is also connected to an exhaust gas recirculation (EGR) passage 6. This EGR passage 6 enables a portion of the exhaust gas to be re-circulated back into the engine's cylinders 7 via an inlet path 8.

To control the time at which the gas exhaust is re-circulated back into the engine's cylinders 7, a valve 9 is provided which may be open, partially open, or closed, and which is located in the EGR passage 6.

A computer processor 10, typically an engine control module (ECM), functions as an information analysis and control centre for the workings of the engine 1 and routinely sends and receives information about the various systems to which it is connected.

When a portion of the exhaust gas is required to be re-circulated into the engine's cylinders via the inlet path 8, the ECM 10 will send a signal to the valve 9 causing it to open. However, during a period when the valve 9 is closed, the pressure of the gas at a position immediately upstream of the valve 9 is substantially the same as the pressure of the gas in the exhaust pipe 4 immediately upstream of the particulate filter 3.

A pressure sensor 11, located in the EGR passage 6, is arranged to sense the pressure of the gas immediately upstream of the valve 9. During such time when the valve 9 is closed, the ECM 10 will transmit a signal to the pressure sensor 11 causing it to sense the pressure of the exhaust gas in the EGR passage 6. The pressure sensor 11 will then send a signal indicative of the gas pressure to the ECM 10.

The ECM 10 will then derive a pressure reduction value corresponding to the signal generated by the pressure sensor 11 which is indicative of the pressure reduction across the particulate filter 3. This is achieved through use of a pre-programmable ‘look-up table’ or equivalent application.

A ‘look-up table’ is a reference information table that enables one or more unknown values (e.g. a pressure reduction value) to be determined from one or more known values (e.g. sensor generated value). This is possible by programming the ECM 10 with the applicable software i.e. a ‘look-up table’ comprising the known values and the corresponding unknown values. The corresponding values will have been calculated from previous experimental data by a standard method known in the art.

The ECM 10 is able to evaluate whether derived pressure reduction value exceeds a predetermined maximum acceptable pressure difference across the particulate filter 3. Should the pressure reduction value exceed the predetermined value, the ECM 10 generates a signal causing initiation of a filter regeneration process.

The regeneration process, which may be controlled by the ECM 10, typically comprises a controlled thermal heating of the particulate filter 3 to approximately 800 degrees Celsius. This is achieved by manipulating the air and fuel parameters such that the temperature of the engine exhaust gas to is raised to a level sufficient to react with the particulate matter trapped in the particulate filter 3. Alternatively, the ECM 10 may control regeneration by commanding an electric heater, engaged with the particulate filter 3, to initiate.

Immediately following the regeneration of the filter, the ECM 10 for example, will signal to the pressure sensor 11 to sense again the pressure of the exhaust gas in the EGR passage 6 and to perform again the steps previously described to enable the ECM 10 to derive pressure reduction are repeated to arrive at a new pressure reduction value. Each time that a pressure reduction value is derived (both prior to and post regeneration of the filter) these values are stored within the ECM 10.

If the ECM 10 finds that the new pressure reduction value is still above the maximum acceptable predetermined value it may respond by producing an output signal, e.g. in the form of a fault code, which would be recognisable to a skilled technician as an indication that the particulate filter 3 is no longer functioning effectively.

It is apparent that the predetermined value and the look-up table become increasingly inaccurate over the lifetime of the engine 1. The ECM 10, can therefore utilise the previously stored pressure reduction values to modify both the values in the look-up table and the predetermined value to ensure that these parameters remain accurate for the purposes of calculating future pressure reduction values over the lifetime of the engine 1.

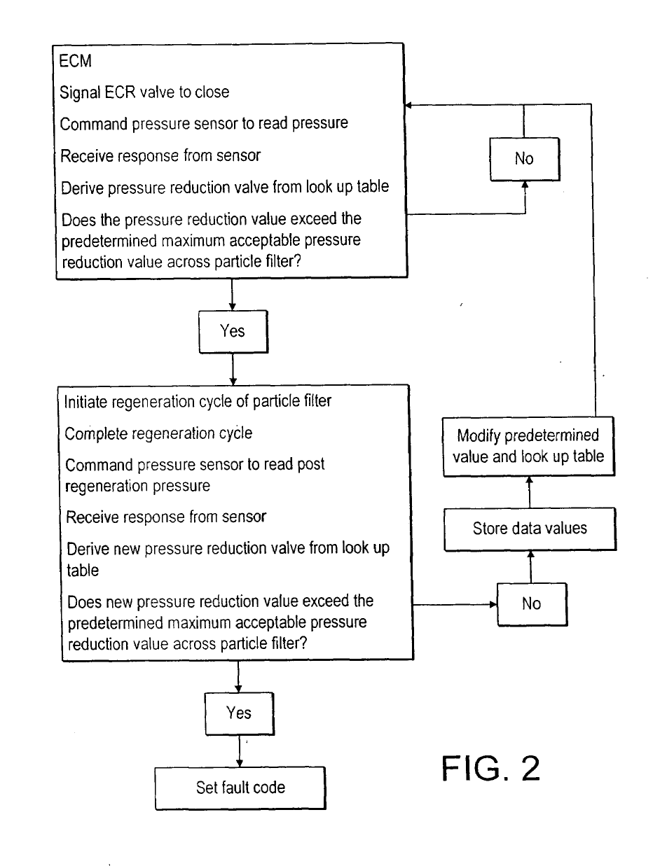

FIG. 2 illustrates a working flow diagram which describes the major steps undertaken to monitor a particulate filter effectively in accordance with the preferred embodiments of the present invention.

Accordingly, reference should be made to the claims rather than the above specific description in understanding the scope of the invention.

1. Apparatus for monitoring the condition of a particulate filter situated within the exhaust flow path of a combustion engine, which combustion engine comprises a plurality of combustion cylinders and is provided with means defining a feedback path for causing a portion of the exhaust gas from the cylinders to flow back to an inlet of the cylinders, there being provided within the feedback path a pressure sensor for measuring the pressure of the gas within the feedback path and for generating an output signal in response thereto, the apparatus comprising:
means for evaluating the output signal to determine whether the pressure within the feedback path has exceeded a predetermined value; and
means responsive to a positive determination of the evaluating means for providing an indication of an unacceptable condition of the particulate filter.

2. Apparatus as claimed in claim 1, in which the feedback path is provided with a valve for selectively causing an open and a closed condition of the feedback path, the apparatus further comprising means for sensing a closed condition of the valve and for enabling the generation of an output signal only when the valve is sensed by the sensing means as being in a closed condition.

3. Apparatus for monitoring the condition of a particulate filter situated within the exhaust flow path of a combustion engine, the apparatus comprising;
means defining an exhaust gas recirculation (EGR) passage;
means located within said exhaust gas recirculation (EGR) passage for sensing pressure and generating a signal indicative thereof; and
computing means arranged to derive a pressure reduction value corresponding to the signal generated by said pressure-sensing means and to determine whether said pressure reduction value exceeds a predetermined value, thereby to provide an indication of an unacceptable condition of the particulate filter.

4. Apparatus as claimed in claim 3, in which the EGR passage is provided with a valve, arranged to selectively open or close the EGR passage, thereby to control the flow of exhaust gas through the EGR passage, the apparatus further comprising means for sensing a closed condition of the valve and for enabling the generation of the signal by the pressure sensing means only when the valve is sensed by the sensing means as being in a closed condition.

5. Apparatus as claimed in claim 4, in which the pressure sensing means is located on the upstream side of the valve in the EGR passage.

6. Apparatus as claimed in claim 4, in which the computing means or receiving means is an Engine Control Module.

7. Apparatus as claimed in any preceding claim, further comprising a look-up table for mapping a plurality of possible values of the output of the signal with corresponding values for the pressure differences across the particulate filter which have been obtained empirically, thereby to determine an evaluation of whether of the pressure in the EGR passage, or feedback path, exceeds the value of the maximum acceptable pressure difference across the particulate filter.

8. Apparatus as claimed in claim 3, further comprising a filter regenerating means, in which the computing means is arranged to cause initiation of the filter regeneration means when said pressure reduction value exceeds said predetermined value.

9. Apparatus as claimed in claim 1, further comprising a filter regenerating means operable in response to a positive determination that said pressure reduction value exceeds said predetermined value.

10. A method of monitoring the condition of a particulate filter situated within the exhaust flow path of a combustion engine, which combustion engine comprises a plurality of combustion cylinders and is provided with means defining a feedback path for causing a portion of the exhaust gas from the cylinders to flow back to an inlet of the cylinders, there being provided within the feedback path a pressure sensor for measuring the pressure of the gas within the feedback path and for generating an output signal in response thereto, the method comprising:
evaluating the output signal to determine whether the pressure within the feedback path has exceeded a predetermined value; and
responding to a positive determination that the predetermined value has been exceeded, thereby to provide an indication of an unacceptable condition of the particulate filter.

11. A method as claimed in claim 10, in which the feedback path is provided with a valve for selectively causing an open and a closed condition of the feedback path, the method further comprising sensing a closed condition of the valve and enabling the generation of the output signal when the valve is sensed by the sensing means as being in a closed condition.

12. A method for monitoring the condition of a particulate filter situated in an exhaust of a combustion engine, comprising the steps of:
sensing pressure of exhaust gas within a means defining an exhaust gas recirculation (EGR) passage using a pressure sensor;
generating a signal indicative of said pressure to a computing means;
deriving a pressure reduction value indicative of said pressure value; and
determining whether said pressure reduction value exceeds a predetermined value, thereby to provide an indication of an unacceptable condition of the particulate filter.

13. A method as claimed in claim 12, in which the EGR passage is provided with a valve, arranged to open or close the EGR passage, thereby to control the flow of exhaust gas through the EGR passage, the method further comprising sensing a closed condition of the valve and enabling the generation of the signal by the pressure sensing means only when the valve is sensed as being in a closed condition.

14. A method as claimed in claim 13, in which the pressure sensing means is located on the upstream side of the valve in the EGR passage.

15. A method as claimed in claim 10, further comprising providing a look-up table for mapping a plurality of possible values of the output of the signal with corresponding values for the pressure differences across the particulate filter which have been obtained empirically, thereby to determine an evaluation of the pressure in the feedback path, exceeds the value of the maximum acceptable pressure difference across the particulate filter.

16. A method as claimed in claim 12, further comprising providing a look-up table for mapping a plurality of possible values of the output of the signal with corresponding values for the pressure differences across the particulate filter which have been obtained empirically, thereby to determine whether the pressure in the EGR passage, exceeds the value of the maximum acceptable pressure difference across the particulate filter.

17. A method as claimed in claim 10 further comprising the step of:
initiating filter regeneration when said pressure reduction value exceeds said predetermined value.

18. A method as claimed in claim 12 further comprising the step of:
initiating filter regeneration when said pressure reduction value exceeds said predetermined value.

19. A method according to claim 17 further comprising:
measuring a second pressure reduction value of the exhaust gas in the feed back path immediately after said filter regeneration is complete.

20. A method according to claim 18 further comprising:
deriving a second pressure reduction value indicative of said pressure value immediately after said filter regeneration is complete.

21. A method according to claim 15 or claim 16 further comprising:
modifying the look-up table; and
modifying the predetermined pressure value, via use of an algorithm such that said look-up table and said predetermined pressure value remain accurate over the lifetime of the internal combustion engine.
